(19) United States
(12) Patent Application Publication
(10) Pub. No.: US 2013/0290177 A1
(43) Pub. Date: Oct. 31, 2013

(54) SYSTEMS AND METHODS FOR FACILITATING PROCESSING OF ELECTRONIC PAYMENTS

(71) Applicants: Amy Christine Milam, Wentzville, MO (US); Stephen Joseph Klaus, St. Louis, MO (US)

(72) Inventors: Amy Christine Milam, Wentzville, MO (US); Stephen Joseph Klaus, St. Louis, MO (US)

(21) Appl. No.: 13/457,222

(22) Filed: Apr. 26, 2012

(51) Int. Cl. G06Q 40/00

(52) U.S. Cl. 705/40

(57) ABSTRACT

A computer system for use with a database that includes a directory of electronic payees is provided. The computer system includes a memory device and a processor. The computer system is programmed to receive a payee file that includes payee information about a payee, verify whether the payee is included in the directory of electronic payees based on the payee information about the payee, and generate an output file that includes the payee information and one of an electronic payee identifier if a verification is confirmed and an indicator that no match was verified.

### BACKGROUND OF THE INVENTION

The field of the invention relates generally to systems and methods for electronic bill payment, and more particularly to network-based systems and methods for facilitating processing of electronic payments by matching payee information, entered on behalf of a payor for a bill being paid by the payor, to biller data stored within a biller database, wherein in the case of a match a biller stored within the biller database is associated with the payee information.

Known electronic bill presentment and payment systems enable users to receive and pay bills electronically. Initially, a user must identify a potential biller/payee to the system. Typically, in known systems, the user identifies a potential payee by name and by a payee zip code. For example, the user may have a paper bill that the user desires to pay electronically. Using the payee name and remittance address on the paper bill, the user identifies the payee to the system. Known systems compare the payee name and zip code to payees that are known to the system. More particularly, known systems may maintain a database of payees that includes information on how to transfer payments to the payee electronically, e.g., using EFT. In addition, some known bill payment systems use a payment network, such as the MasterCard® Network, to transfer payments from users to payees (MasterCard is a registered trademark of MasterCard International, of Purchase, New York).

After the user's payee is matched to a known payee, the user may receive bills and submit payments electronically through the system. If the user's payee cannot be matched to a known payee, payment generally cannot be sent electronically and must be sent via paper check. Payments sent non-electronically cause unwanted burdens and delays to users, payment systems, and payees.

Accordingly, a system and method for facilitating electronic payments by reducing non-electronic payments is desired. More particularly, a system and method for more accurately and efficiently matching entered payee information to stored biller information is desired.

### BRIEF DESCRIPTION OF THE INVENTION

In one embodiment, a computer system for verifying payee information in an electronic payment is provided. The computer system includes a memory device and a processor. The computer system is programmed to receive a payee file that includes payee information identifying a payee, wherein the payee issues a bill for payment to a payor, determine a match score by comparing the payee information with biller information stored within a directory of electronic billers, verify that the payee matches at least one electronic biller stored within the directory of electronic billers based on the match score, and generate an output file that includes one of an electronic biller identifier corresponding to the payee in the payee file if verification is confirmed and an indicator that no match was verified.

In another embodiment, a computer-based method for verifying electronic payees using a computer device in communication with a database that includes a directory of electronic billers is provided. The method includes receiving a payee file that includes payee information identifying a payee, wherein the payee issues a bill for payment to a payor, determining a match score by comparing the payee information with biller information stored within a directory of electronic billers, verifying that the payee matches at least one electronic biller stored within the directory of electronic billers based on the match score, and generating an output file including at least one of an electronic biller identifier corresponding to the payee in the payee file if verification is confirmed and an indicator that no match was verified.

In yet another embodiment, at least one non-transitory computer-readable storage media having computer-executable instructions embodied thereon is provided. When executed by at least one processor, the computer-executable instructions cause the processor to receive a payee file that includes payee information identifying a payee, wherein the payee issues a bill for payment to a payor, determine a match score by comparing the payee information with biller information stored within a directory of electronic billers, verify that the payee matches at least one electronic biller stored within the directory of electronic billers based on the match score, and generate an output file including at least one of an electronic biller identifier that corresponds to the payee in the payee file if verification is confirmed and an indicator that no match was verified.

### BRIEF DESCRIPTION OF THE DRAWINGS

FIGS. 1-7 show exemplary embodiments of the methods and systems described herein.

FIG. 1 is a schematic diagram illustrating an exemplary system for maximizing electronic payments.

FIG. 2 illustrates an exemplary configuration of a server system that may be used to implement the system shown in FIG. 1.

FIG. 3 is a block diagram illustrating an exemplary payee verification processor that may be used with the system shown in FIG. 1.

FIG. 4 is a data flow diagram of the payee verification processor shown in FIG. 3.

FIG. 5 illustrates an exemplary configuration of a client system that may be used with the system shown in FIG. 1.

FIG. 6A is a simplified block diagram of a conventional electronic financial service system.

FIG. 6B is a further depiction of the conventional electronic financial service system shown in FIG. 6A.

FIG. 7 is a simplified block diagram of an exemplary payment system for use with the system shown in FIG. 1.

### DETAILED DESCRIPTION OF THE INVENTION

Embodiments of the present invention facilitate the efficient transfer of money by identifying electronic payment methods that may be used to replace traditional and less effective payment methods. A biller database is provided that stores information about known billers to whom electronic payments may be sent. Biller information includes known billers registered within the system, wherein the biller information has been verified as accurate. A list of potential payments, including payee information, is compared with the biller information stored within the biller database to determine and verify whether the payee is in the biller database. A matching score is determined based on the comparison of payees to billers or, more specifically, payee information to biller information. More particularly, a matching score is based on a comparison of payee name, payee remittance address, payee state, payee zip, and payee consumer account number with corresponding biller information stored in the biller database. Generally speaking, the match with the highest score is used to pair the payee with the appropriate biller. A confidence score is generated based on the comparison of the paired payee and the biller. If the confidence score reaches a pre-determined threshold, the pair is reported as a successful match, indicating that the payment may be sent to the biller matching the payee information via an electronic method, thus increasing the number of payments that may be sent electronically.

In one embodiment, a computer program is provided, and the program is embodied on a computer readable medium. In an exemplary embodiment, the system is executed on a single computer system, without requiring a connection to a sever computer. In a further exemplary embodiment, the system is being run in a Windows® environment (Windows is a registered trademark of Microsoft Corporation, Redmond, Wash.). In yet another embodiment, the system is run on a mainframe environment and a UNIX® server environment (UNIX is a registered trademark of X/Open Company Limited located in Reading, Berkshire, United Kingdom). The application is flexible and designed to run in various different environments without compromising any major functionality. In some embodiments, the system includes multiple components distributed among a plurality of computing devices. One or more components may be in the form of computer-executable instructions embodied in a computer-readable medium. The systems and processes are not limited to the specific embodiments described herein. In addition, components of each system and each process can be practiced independent and separate from other components and processes described herein. Each component and process can also be used in combination with other assembly packages and processes.

The following detailed description illustrates embodiments of the invention by way of example and not by way of limitation. It is contemplated that the invention has general application to processing financial transaction data by a third party in industrial, commercial, and residential applications.

As used herein, an element or step recited in the singular and proceeded with the word “a” or “an” should be understood as not excluding plural elements or steps, unless such exclusion is explicitly recited. Furthermore, references to “example embodiment” or “one embodiment” of the present invention are not intended to be interpreted as excluding the existence of additional embodiments that also incorporate the recited features.

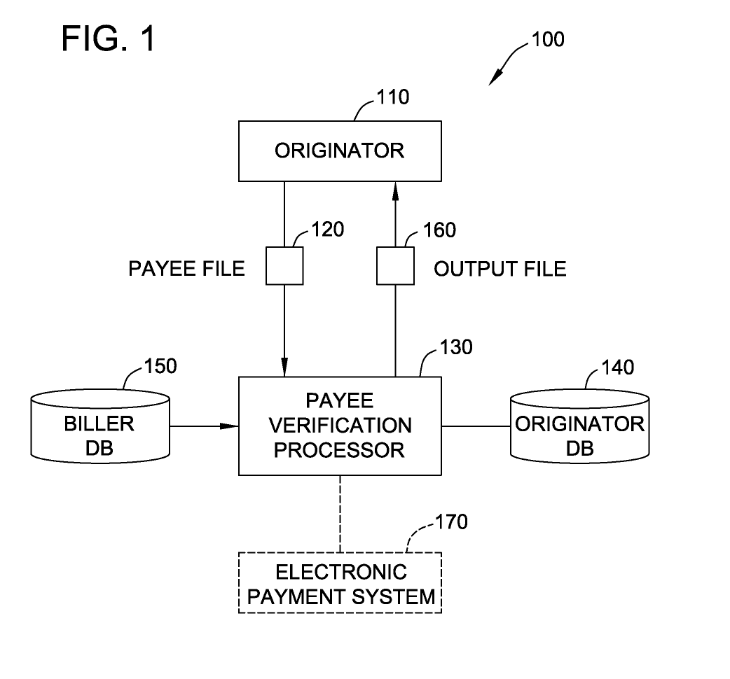

FIG. 1 illustrates an exemplary system 100 for processing electronic payments using a payee verification processor in accordance with the present invention. In the exemplary embodiment, an originator 110 generates and transmits a payee file 120 to a payee verification processor 130. Originator 110 may be a customer of the operator of payee verification processor 130, the operator of payee verification processor 130, and/or any other party. More particularly, originator 110 may be a bank, a bill presentment and payment service, and/or a bill payment aggregator. Customers, or payors, make payment(s) and provide payee information to originator 110, e.g., online or in person. For example, a payor could give an amount due (i.e., from a bill) to a payee (e.g., a utility company, a cell phone company, etc.) to originator 110 with payee information. Originator 110 generates payee file 120 using payee information provided by the payor. Payee file 120 contains one or more payee records to be analyzed by payee verification processor 130. For example, payee file 120 may contain pipe-delimited text in a header record (see Table 1), one or more detail records (see Table 2), and a trailer record (see Table 3). Alternatively, or additionally, payee file 120 may be in any format that enables system 100 to function as described herein. The records shown herein in Tables 1, 2, and 3 are illustrative only and are not intended to be exhaustive or limiting. Payee file 120 could include other data without departing from the scope of the present invention.

TABLE 1
Header Record

| Field | Field Number | Usage |
|---|---|---|
| Record Type Indicator | 1 | A literal value of ‘1’ |
| Originator ID | 2 | A valid originator ID |
| Transmission Date | 3 | MMDDCCYY |
| Transmission Time | 4 | HHMM |
| Line of Business | 5 | RB—Remote Banking; |
| | | CC—Credit Counseling |

TABLE 2
Detail Record

| Field | Field Number | Usage |
|---|---|---|
| Record Type Indicator | 1 | A literal value of ‘6’ |
| Payee Name | 2 | Field could be empty |
| Payee Street Address 1 | 3 | Field could be empty |
| Payee Street Address 2 | 4 | Field could be empty |
| Payee City | 5 | |
| Payee State | 6 | |
| Payee Zip/Zip + 4 | 7 | |
| Payee Consumer Account | 8 | i.e., the payer’s account |
| Number | | number with payee |
| Originator DB Key 1 | 9 | Field could be empty |
| Originator DB Key 2 | 10 | Field could be empty |
| Originator DB Key 3 | 11 | Field could be empty |
| Originator DB Key 4 | 12 | Field could be empty |
| Consumer Name | 13 | The person/entity |
| | | associated with the |
| | | consumer account number |
| Consumer Street Address 1 | 14 | |
| Consumer Street Address 2 | 15 | |
| Consumer City | 16 | |
| Consumer State | 17 | |
| Consumer Zip | 18 | |
| Consumer Phone Number | 19 | |
| Payment Amount | 20 | |

TABLE 3
Trailer Record

| Field | Field Number | Usage |
|---|---|---|
| Record Type Indicator | 1 | A literal value of ‘9’ |
| Originator ID | 2 | A valid originator ID |
| Total number of records | 3 | Total of all detail records |

Payee information in payee file 120 may be provided by payors and may contain errors, such as spelling errors, transposition errors, use of payee nicknames rather than official names (i.e., “MC” for “MasterCard®”), and/or omissions. In addition, payee information provided by the payor may be out-of-date, such as when a payee moves or changes names. System 100 improves the quality and number of matches between provided payee information and payees actually capable of receiving electronic payments (also referred to herein as “billers” or “biller information”), thereby facilitating increased usage of electronic payments by identifying payees in payee file 120 capable of receiving electronic payments.

Payee verification processor 130 verifies that originator 110 is a valid originator by comparing an originator ID, e.g., from a header record of payee file 120, with an originator database 140. Originator database 140 stores an originator ID and originator profile information for each valid originator 110. For example, payee verification service may be provided by payee verification processor 130 on a subscription and/or per-use basis, and originator database 140 may contain all originators 110 with paid subscriptions and/or authorization to use payee verification processor 130 on a per-use basis.

Payee verification processor 130 compares each payee in payee file 120 with known billers in a biller database 150 to determine whether the payee is in biller database 150. By convention, the entities in payee file 120 are referred to as payees, and the entities in biller database 150 are referred to as billers, however, it should be understood that the two entities may be the same, and that payee verification processor 130 facilitates determining whether payees are stored in biller database 150. Moreover, the collection of billers in biller database 150 may be referred to as a directory of electronic payees or billers, wherein each biller is an electronic payee or electronic biller.

As will be explained in more detail herein, payee verification processor 130 analyzes each payee in payee file 120 to determine whether each payee matches a biller in biller database 150. Payee verification processor 130 generates an output file 160 that corresponds to payee file 120. For each payee in payee file 120, payee verification processor 130 indicates, in output file 160, which biller is matched to each payee or whether no match was made. Alternatively, output file 160 may omit payees for which no match was made. Output file 160 may contain pipe-delimited text in a header record (see Table 4), one or more detail records (see Table 5), and a trailer record (see Table 6). Additionally, detail records in output file 160 may contain unedited information from corresponding detail records in payee file 120.

TABLE 4
Header Record

| Field | Field Number | Usage |
|---|---|---|
| Record Type Indicator | 1 | A literal value of ‘1’ |
| Originator ID | 2 | Originator ID |
| Transmission Date | 3 | MMDDCCYY |
| Transmission Time | 4 | HHMM |
| Line of Business | 5 | RB—Remote Banking; |
| | | CC—Credit Counseling |
| Full File Error | 6 | An error message |

TABLE 5
Detail Record

| Field | Field Number | Usage |
|---|---|---|
| Record Type Indicator | 1 | A literal value of ‘6’ |
| Payee name | 2 | Data is populated from the |
| | | originator’s inbound file |
| Payee Street Address 1 | 3 | Data is populated from the |
| | | originator’s inbound file |
| Payee Street Address 2 | 4 | Data is populated from the |
| | | originator’s inbound file |
| Payee City | 5 | Data is populated from the |
| | | originator’s inbound file |
| Payee State | 6 | Data is populated from the |
| | | originator’s inbound file |
| Payee Zip/Zip + 4 | 7 | Data is populated from the |
| | | originator’s inbound file |
| Payee Consumer Account | 8 | Data is populated from the |
| Number | | originator’s inbound file |
| Originator DB Key 1 | 9 | Data is populated from the |
| | | originator’s inbound file |
| Originator DB Key 2 | 10 | Data is populated from the |
| | | originator’s inbound file |
| Originator DB Key 3 | 11 | Data is populated from the |
| | | originator’s inbound file |
| Originator DB Key 4 | 12 | Data is populated from the |
| | | originator’s inbound file |
| Biller ID or Error | 13 | A matched biller ID or an |
| | | error message |
| Overall Level of | 14 | Confidence score for |
| Confidence | | payee |
| Revised Consumer | 15 | Data is populated for an |
| Account Number | | account number if a payee |
| | | record is assigned a match |
| | | and the payee consumer |
| | | account number had to be |
| | | manipulated to match an |
| | | account mask or because |
| | | the account number has |
| | | changed |
| Payment Creation Type | 16 | Data is populated for |
| | | electronic payment if a |
| | | biller ID is assigned to a |
| | | payee record during the |
| | | matching process |
| Consumer Name | 17 | The person/entity |
| | | associated with the |
| | | Consumer Account |
| | | Number |
| Consumer Street Address 1 | 18 | |
| Consumer Street Address 2 | 19 | |
| Consumer City | 20 | |
| Consumer State | 21 | |
| Consumer Zip | 22 | |
| Consumer Phone Number | 23 | |
| Payment Amount | 24 | |
| Payment Confirmation | 25 | If payment was made, a |
| Number | | confirmation/trace number |

TABLE 6
Trailer Record

| Field | Field Number | Usage |
|---|---|---|
| Record Type Indicator | 1 | A literal value of ‘9’ |
| Originator ID | 2 | Same as header record; |
| | | originator ID |
| Total number of records | 3 | Total of all processed |
| | | detail records |

Biller database 150 may also store the preferred format of consumer account numbers as an account mask. For example, a consumer account number may be in the form of “E-123456789”. However, a biller may prefer to receive account numbers with the “E-” portion omitted. Accordingly, payee verification processor 130 may, based on the account number formats/masks stored in biller database 150, alter the format of consumer account numbers. Continuing the example above, output file 160 would contain the consumer account number “123456789” rather than “E-123456789”. If a consumer account number is modified by processor 130 (e.g., because the account number changed and/or to match a preferred format), output file 160 may contain, for each payee detail record, the originally-input consumer account number, the altered consumer account number, and/or an indication that the account number was altered.

In one embodiment, payee verification processor 130 is used with, and communicatively coupled to, an electronic payment network or system 170, such as, but not limited to, the MasterCard® Remote Payment Processing System (RPPS) electronic payment system of MasterCard International, of Purchase, New York. Electronic payment system 170 may be any electronic payment system that enables system 100 to function as described herein. Electronic payment system 170 may include biller database 150. Alternatively, payee verification processor 130 may utilize any collection of billers stored in or used with electronic payment system 170.

Electronic payment system 170 and/or biller database 150 may store consumer account numbers that have changed. More particularly, electronic payment system 170 may, for a consumer of a biller, store an old consumer account number and a new consumer account number. For example, a consumer may have a first consumer account number assigned to the consumer, wherein subsequently a new consumer account number (a second consumer account number) is assigned to the consumer for a variety of reasons. The second consumer account will be cross-referenced with the first consumer account number in electronic payment system 170. Payee verification processor 130 may be configured to detect an old consumer account number in payee file 120 and output, in output file 160, the new consumer account number associated with the old consumer account number. For example, if a utility company changes the account number of a consumer, and the consumer submits a payment to the utility company using the old account number, payee verification processor 130 may detect the old account number and output the new account number such that payment is directed to the new account number.

In one embodiment, payee verification processor 130, after matching payees to billers, transmits payments via electronic payment system 170 using payee file 120 in combination with a payment file that includes records of payments to be made to the payees in payee file 120. Alternatively, payee file 120 may contain payment information. A payment confirmation number may be included in output file 160 if payment was made using electronic payment system 170.

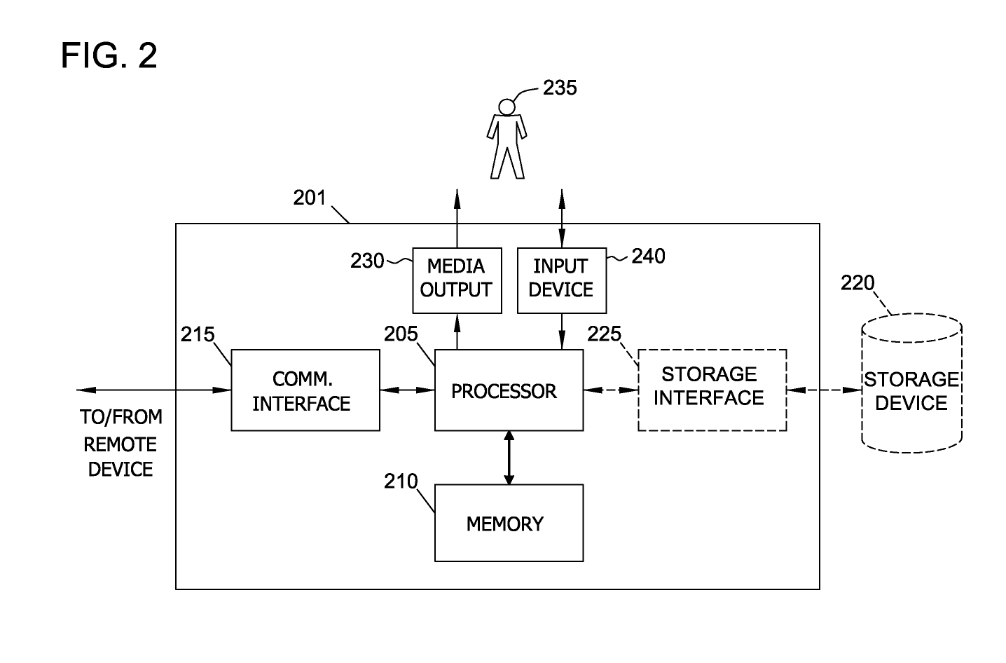

FIG. 2 illustrates an exemplary configuration of a server system 201 that may be used with system 100, e.g., to implement payee verification processor 130. Specifically, server system 201 is a more detailed description of payee verification processor 130 shown in FIG. 1.

Server system 201 includes a processor 205 for executing instructions. Instructions may be stored in a memory area 210, for example. Processor 205 may include one or more processing units (e.g., in a multi-core configuration) for executing instructions. The instructions may be executed within a variety of different operating systems on the server system 201, such as UNIX, LINUX, Microsoft Windows®, etc. It should also be appreciated that upon initiation of a computer-based method, various instructions may be executed during initialization. Some operations may be required in order to perform one or more processes described herein, while other operations may be more general and/or specific to a particular programming language (e.g., C, C#, C++, Java, or other suitable programming languages, etc).

Processor 205 is operatively coupled to a communication interface 215 such that server system 201 is capable of communicating with a remote device such as a user system or another server system 201. Communication interface 215 may include, for example, a wired or wireless network adapter or a wireless data transceiver for use with a mobile phone network, Global System for Mobile communications (GSM), 3G, or other mobile data network or Worldwide Interoperability for Microwave Access (WIMAX). For example, communication interface 215 may communicatively couple with originator 110 via the Internet, or any other network.

Processor 205 may also be operatively coupled to a storage device 220. Storage device 220 is any computer-operated hardware suitable for storing and/or retrieving data. In some embodiments, storage device 220 is integrated in server system 201. For example, server system 201 may include one or more hard disk drives as storage device 220. In other embodiments, storage device 220 is external to server system 201 and may be accessed by a plurality of server systems 201. For example, storage device 220 may include multiple storage units such as hard disks or solid state disks in a redundant array of inexpensive disks (RAID) configuration. Storage device 220 may include a storage area network (SAN) and/or a network attached storage (NAS) system.

In some embodiments, processor 205 is operatively coupled to storage device 220 via a storage interface 225. Storage interface 225 is any component capable of providing processor 205 with access to storage device 220. Storage interface 225 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing processor 205 with access to storage device 220.

Server system 201 may also include at least one media output component 230 for presenting information to a user 235. Media output component 230 is any component capable of conveying information to user 235. In some embodiments, media output component 230 includes an output adapter such as a video adapter and/or an audio adapter. An output adapter is operatively coupled to processor 205 and operatively couplable to an output device such as a display device, a liquid crystal display (LCD), organic light emitting diode (OLED) display, or “electronic ink” display, or an audio output device, a speaker or headphones.

In some embodiments, server system 201 includes an input device 240 for receiving input from user 235. Input device 240 may include, for example, a keyboard, a pointing device, a mouse, a stylus, a touch sensitive panel, a touch pad, a touch screen, a gyroscope, an accelerometer, a position detector, or an audio input device. A single component such as a touch screen may function as both an output device of media output component 230 and input device 240.

Memory area 210 may include, but are not limited to, random access memory (RAM) such as dynamic RAM (DRAM) or static RAM (SRAM), read-only memory (ROM), erasable programmable read-only memory (EPROM), electrically erasable programmable read-only memory (EEPROM), and non-volatile RAM (NVRAM). The above memory types are exemplary only, and are thus not limiting as to the types of memory usable for storage of a computer program.

Stored in memory area 210 are, for example, computer readable instructions for providing a user interface to user 235 via media output component 230 and, optionally, receiving and processing input from input device 240. A user interface may include, among other possibilities, a web browser and client application. Web browsers enable users, such as user 235, to display and interact with media and other information typically embedded on a web page or a website from server system 201. A client application allows user 235 to interact with a server application, e.g., some or all of payee verification processor 130, from server system 201.

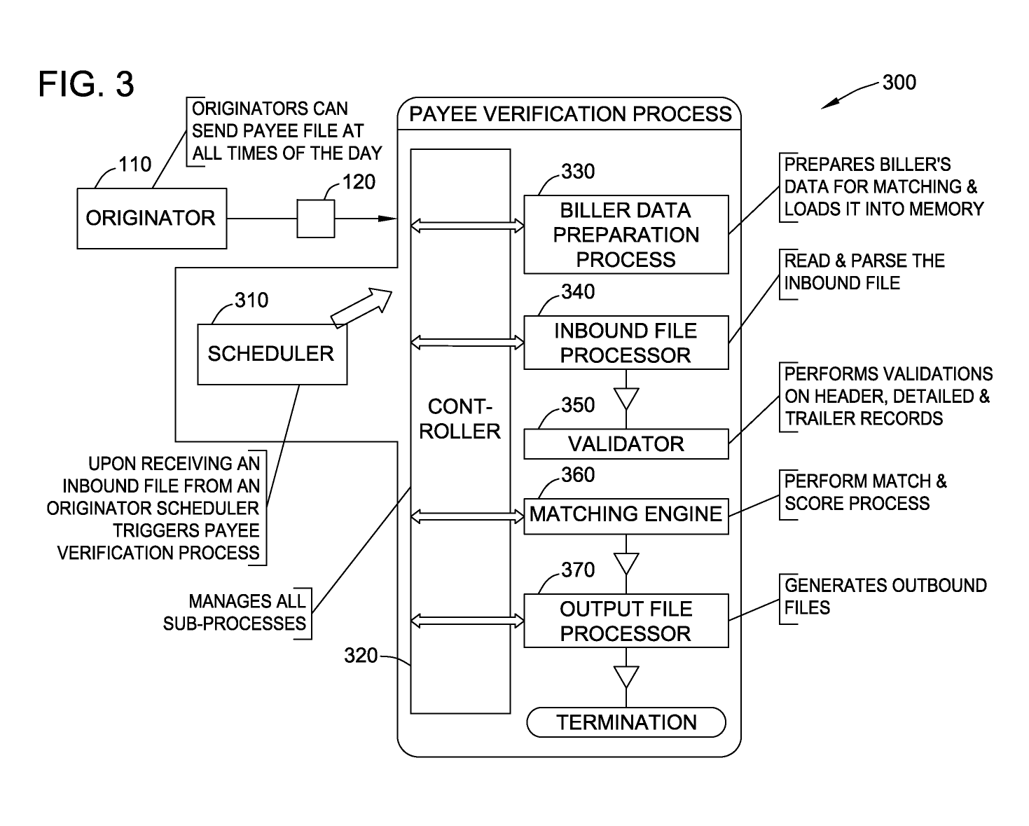

FIG. 3 illustrates a block diagram of an exemplary payee verification processor 300 that may be used with system 100. Originator 110 transmits payee file 120 to payee verification processor 300. In the exemplary embodiment, a scheduler 310 coordinates the processing of payee file 120 using a controller 320 when payee file 120 arrives at payee verification processor 300. Alternatively, scheduler 310 may delay the processing of payee file 120 until a pre-determined time, at which time scheduler 310 instructs controller 320 to process payee file 120. Payee verification processor 300 is capable of processing multiple payee files 120 simultaneously, and scheduler 310 and/or controller 320 is capable of coordinating the processes of payee verification processor 300 such that multiple payee files 120 are processed substantially in parallel with each other. For example, if payee verification processor 300 is implemented using Java (Java is a registered trademark of Oracle Corporation, Redwood Shores, California), a new payee verification processor process can be initiated in a different Java Virtual Machine (JVM) for each payee file 120.

Payee verification processor 300 includes a biller data preparation processor 330. Preparation processor 330 is programmed to receive biller data, e.g., from biller database 150, and make biller data available to payee verification processor 300, e.g., from memory 210. Controller 320 may cause preparation processor 330 to receive and/or refresh biller data at regular intervals, upon the receipt of payee file 120, and/or at any suitable time. For example, controller 320 may instruct preparation processor 330 to query biller database 150 for changes to biller or account information.

An inbound file processor 340 reads and parses the data in payee file 120. A validator 350 checks the format of data in payee file 120 against a pre-determined standard, and if payee file 120 is non-compliant, validator 350 may cause processing of payee file 120 to be halted and may cause an error message to be set in the header record of output file 160. Inbound file processor 340 and/or validator 350 may cleanse the data in payee file 120 by removing special characters, e.g., !@#$%̂&*()_+˜{}:”<>?'−=[]\;’,./, removing spaces from account numbers, and/or removing dashes from account numbers.

Payee verification processor 300 includes a matching engine 360 that matches payees in payee file 120 with billers in biller database 150. An output file processor 370 generates output file 160 for each payee file 120 and based on the output of matching engine 360.

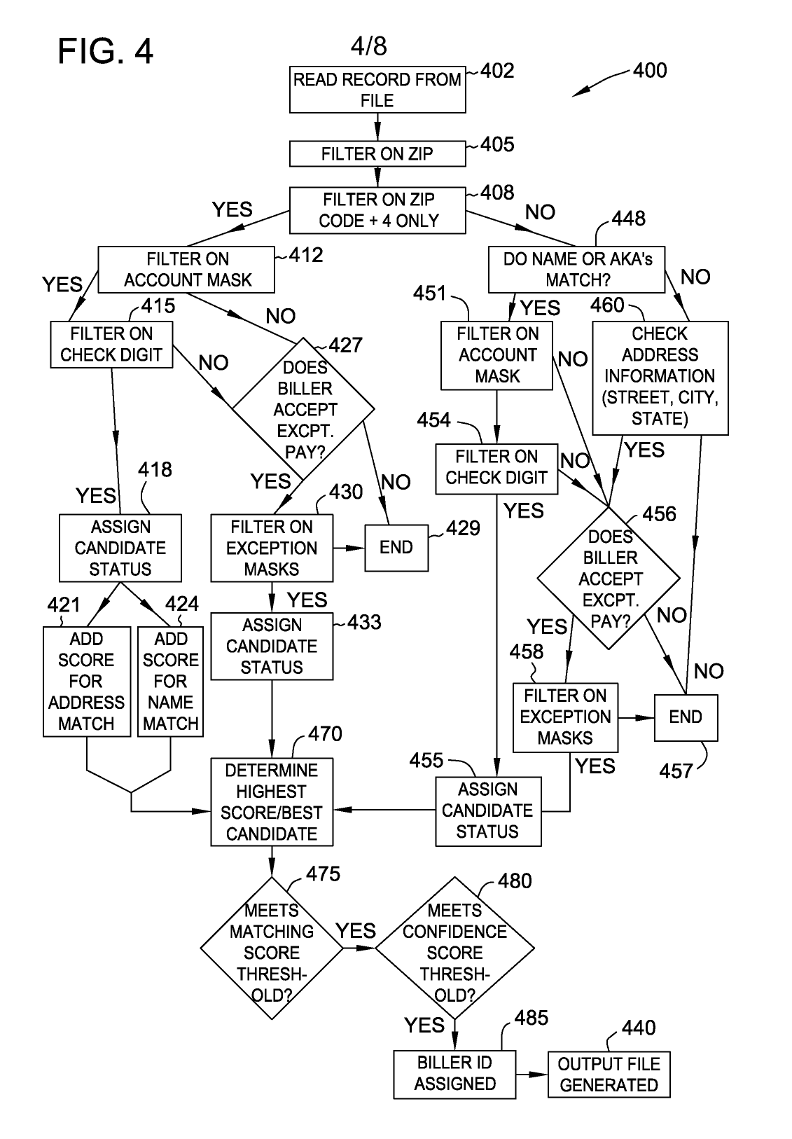

FIG. 4 illustrates an exemplary process 400 for generating matches and scores using payee verification processor 130 and/or 300. More particularly, matching engine 360 may be used to execute steps 405-485, defined herein. In the example of FIG. 4, operations 405-485 are illustrated in sequential order. However, it should be appreciated that process 400 illustrates non-limiting examples of operations of the processor 130, 300 and/or matching engine 360. For example, two or more operations of the operations 405-485 may be executed in a partially or completely overlapping or parallel manner. In other examples, operations may be performed in a different order than that shown. Further, additional or alternative operations may be included. Moreover, more than one iteration of steps 405-485 may be performed.

Each payee detail record is read 402 from payee file 120. Each payee will be compared against each biller in biller database 150, however, for computational efficiency, the collection of billers in biller database 150 may be filtered, e.g., using a constrained database query. Initially, the collection of billers may be filtered 405 using the payee zip code. In other words, billers that do not match the payee zip code are ignored. The following steps are performed with each filtered biller to determine whether the biller is a potential match candidate. Each potential match candidate is assigned a match score and a confidence score.

As each payee may have more than one potential match candidate, match scores are used to determine the best match. A confidence score is also calculated. In the exemplary embodiment, a confidence score is calculated contemporaneously with the generation of the match score. Alternatively, a confidence score may be calculated after a match score has been calculated or a match is made. A confidence score is a qualitative measure of the confidence in the match, and each originator 110 may have a pre-determined confidence score threshold, below which a biller is not reported as a match. Scores may be awarded based on the exemplary scores shown in Table 7. Alternatively, variable scores may be awarded based on the quality of the match. For example, if a payee name is not an exact match, but is a possible misspelling, a non-zero score that is less than the full score may be awarded. A match score is based on the following data points: scores for zip, state, name, address, and consumer account number comparisons. In other embodiments, a match score may be based on, or take into account, other data points. A confidence score is based on the following data points: scores for zip, state, name, and address comparisons.

In other words, a confidence score is based on a subset of the data points used to determine the match score. As explained in more detail herein, possible matches between payee information and biller information stored within biller database 150 are assigned a match score. As the comparison of payee information to biller information is a one-to-many comparison, match scores may be used to rank each comparison, e.g., in descending order of match scores, with the better matches having higher match scores. The comparison, or match, with the highest score may be considered the best match. If the corresponding confidence score of the best match meets or exceeds a pre-determined threshold, the biller information associated with the best match may be output.

TABLE 7
Exemplary Scores

| Payee Data Element Matching Criteria | Score Assigned |
|---|---|
| Payee Zip: Zip + 4 | 25 |
| Payee Zip: Zip | 20 |
| Payee Zip: No match | 0 |
| Payee State: State | 25 |
| Payee State: No match | 0 |
| Payee Name: Name | 25 |
| Payee Name: AKA | 25 |
| Payee Name: Previous Name | 25 |
| Payee Name: Mask Descriptor | 25 |
| Payee Name: No match | 0 |
| Payee Remit Address: Standard Address | 25 |
| Payee Remit Address: Previous Address | 20 |
| Payee Remit Address: No match | 0 |
| Payee Consumer Account Number: Standard | 25 |
| account mask with check digit | |
| Payee Consumer Account Number: Standard | 20 |
| account mask without check digit | |
| Payee Consumer Account Number: Exception | 15 |
| mask with or without check digit | |
| Payee Consumer Account Number: Exception | 15 |
| biller without any account masks | |
| Payee Consumer Account Number: No match | 0 |
| Payee Consumer Account Number: Standard/ | 0 |
| Exception mask with check digit routine | |
| registered by failed to perform check | |
| digit routine | |

When comparing payee information from payee file 120 with biller information in biller database 150, loose matching techniques may be applied. For example, case-insensitive string comparisons of non-whitespace characters may be used. As another example, vowels may be ignored in a comparison. Phonetic, i.e., “sounds like”, matching may also be used. When an exact match of corresponding fields is not successful, a variable score may be awarded as described herein. Alternatively, full scores, such as those in the tables herein, may be awarded.

Each filtered biller is compared 408 with the payee based on the payee zip+4. If the biller zip+4 matches the payee zip+4, a pre-determined score is given to the biller and the payee consumer account number is compared 412 with the biller account mask. An account mask is a regular expression and/or any other mask used to indicate an expected string format, including, but not limited to, a number of digits, placement of alpha characters, etc. If the payee consumer account number matches the biller account mask, a pre-determined score is given to the biller and the payee consumer account number is verified 415 using a check digit routine. The check digit routine may be specific to each biller, and may be any algorithm used to verify the authenticity, internal consistency, redundancy, and/or integrity of the payee consumer account number. The check digit routine may be any known or suitable check digit routine commonly used for error detection. The check digit routine may be performed using any server system 201, including, but not limited to, payee verification processor 130 and electronic payment system 170.

If the check digit routine succeeds, a pre-determined score is given to the biller, and the biller is assigned 418 match candidate status. The biller is given 421 a pre-determined score based on a comparison of the payee address and the current and/or previous biller addresses. The biller is given 424 a pre-determined score based on a comparison of the payee name and the biller name, biller also-known-as names, biller previous name, and/or a biller name mask.

If either the account mask comparison or the check digit routine failed, it is determined 427 whether the biller accepts exception payments. As a matter of background, a biller may consider any check payment generated through an on-line banking service as an exception item as the payment does not include remittance advice, coupon or payment stub. These on-line payments typically do not flow through the biller's traditional lockbox remittance processing system and require manual intervention to post correctly. Therefore, these on-line payments can be considered an exception item or an exception payment. If the biller does not accept exception payments, the biller is no longer considered as a potential match candidate 429. If the biller accepts exception payments, the payee consumer account number is compared 430 with one or more biller exception masks to determine, based on the payee consumer account number, whether the biller will accept an exception payment. If the payee consumer account number does not match an exception mask, the biller is not considered a potential match candidate 429. If the payee consumer account number matches an exception mask, the biller is given 433 match candidate status.

If, however, the biller zip+4 does not match the payee zip+4, a different pre-determined score is given to the biller, and the payee name and biller name, biller also-known-as name, biller previous name, and/or a biller name mask are compared 448. If a match is found, a pre-determined score is given to the biller and the payee consumer account number is compared 451 with a biller account mask. If the payee consumer account number matches a biller account mask, the payee consumer account number is checked 454 against a biller check digit routine. If the check digit routine succeeds, the biller is assigned 455 match candidate status. If the account mask does not match or the check digit routine fails, it is determined 456 whether the biller accepts exception payments. If the biller does not accept exception payments, the biller is no longer considered a potential match candidate 457. If the biller accepts exception payments, the payee consumer account number is compared 458 with one or more biller exception masks. If no biller exception mask matches the payee consumer account number, the biller is no longer considered a potential match candidate 457. If a biller exception mask matches the payee consumer account number, the biller is assigned match candidate status 455.

If the biller name did not match at step 448, the payee address, city, and/or state are compared 460 with the biller address, city, and/or state. If the address, city, and state do not match, the biller is no longer considered a potential candidate match 463. If the address, city, and/or state match, it is determined 456 whether the biller accepts exception payments.

It should be appreciated that pre-determined scores may be given in any or all of the foregoing steps. Also, a biller may not have a check digit routine, an account number mask, and/or an exception mask, in which case the biller may be processed as if each of the foregoing three tests was successful.

After all billers in biller database 150 have been filtered, removed from consideration, or given match candidate status, the best candidate is determined 470. In the event that more than one candidate is identified, the biller with the highest matching score should be assigned as the best possible match. In the event that the matching score is the same for more than one biller, the biller with the highest payee consumer account number score should be assigned as the best possible match. In the event that the matching score and the payee consumer account number score are the same for more than one match, the match with the highest combined payee state and payee zip scores should be assigned as the best possible match.

In the event that the matching score, the payee consumer account number score, and the combined payee state and zip scores are the same for more than one biller, the biller with the highest payee name score should be assigned as the best possible match. In the event that the matching score, the payee consumer account number score, the combined payee state and zip scores, and the payee name score are the same for more than one biller, the first biller identified as a candidate should be assigned as the best possible match.

A pre-determined matching score threshold may be used to determine 475 whether the best possible match should be reported, i.e., in output file 160, as a match. If the best possible match for a payee does not meet or exceed the pre-determined matching score threshold, no match is reported.

A pre-determined confidence score threshold may be used to determine 480 whether the best possible match should be reported. Each originator 110 may have a pre-determined confidence score threshold that is stored in originator database 140. If the best possible match for a payee does not meet or exceed the pre-determined confidence score threshold, no match should be made.

If a match is made, then a biller ID is assigned 485 to the payee. Each biller has a biller ID that is stored in biller database 150 and uniquely identifies each biller. Finally, output file 160 is generated 490. Output file 160, as described herein, contains a record for each payee in payee file 120. Outbound file 160 further contains, for each payee, either a matched biller ID or an indication that no match was made. Alternatively, two outbound files may be generated 490. A first outbound file may contain payee records that are matched to a biller ID and have a confidence score that meets or exceeds originator's pre-determined confidence score threshold. A second outbound file may contain the records of the first outbound file and all payee records that are not assigned a match. Alternatively, a second outbound file may contain all payee records having a confidence score below the originator's pre-determined confidence score threshold.

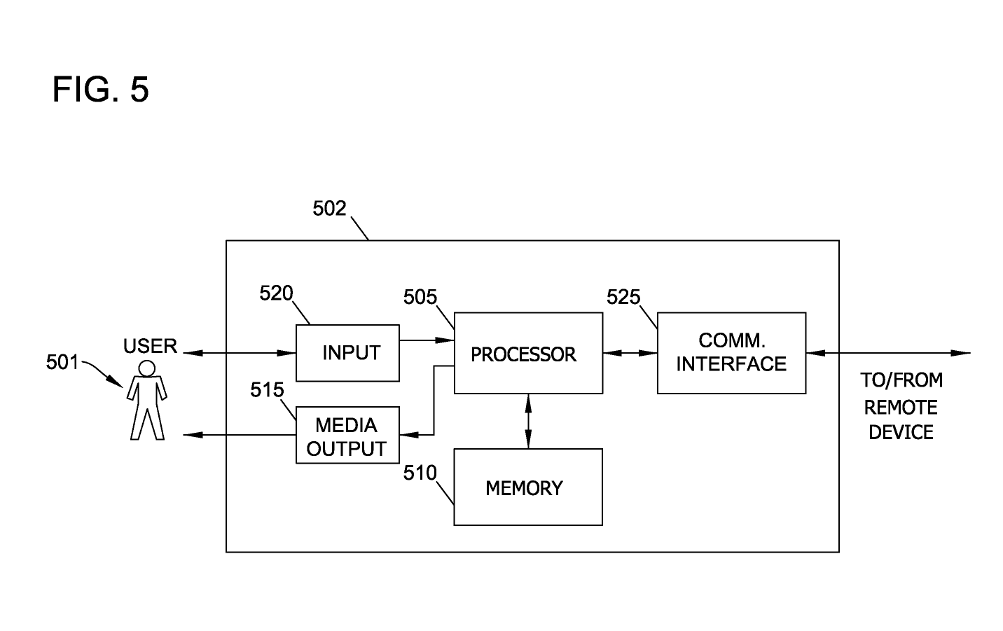

FIG. 5 illustrates an exemplary configuration of a user system 502 operated by a user 501. User system 502 may include, but is not limited to, originator 110. In the exemplary embodiment, user system 502 includes a processor 505 for executing instructions. In some embodiments, executable instructions are stored in a memory area 510. Processor 505 may include one or more processing units, for example, a multi-core configuration. Memory area 510 is any device allowing information such as executable instructions and/or written works to be stored and retrieved. Memory area 510 may include one or more computer readable media.

User system 502 also includes at least one media output component 515 for presenting information to user 501. Media output component 515 is any component capable of conveying information to user 501. In some embodiments, media output component 515 includes an output adapter such as a video adapter and/or an audio adapter. An output adapter is operatively coupled to processor 505 and operatively couplable to an output device such as a display device, a liquid crystal display (LCD), organic light emitting diode (OLED) display, or “electronic ink” display, or an audio output device, a speaker or headphones.

In some embodiments, user system 502 includes an input device 520 for receiving input from user 501. Input device 520 may include, for example, a keyboard, a pointing device, a mouse, a stylus, a touch sensitive panel, a touch pad, a touch screen, a gyroscope, an accelerometer, a position detector, or an audio input device. A single component such as a touch screen may function as both an output device of media output component 515 and input device 520. User system 502 may also include a communication interface 525, which is communicatively couplable to a remote device such as server system 201. Communication interface 525 may include, for example, a wired or wireless network adapter or a wireless data transceiver for use with a mobile phone network, Global System for Mobile communications (GSM), 3G, or other mobile data network or Worldwide Interoperability for Microwave Access (WIMAX).

Stored in memory area 510 are, for example, computer readable instructions for providing a user interface to user 501 via media output component 515 and, optionally, receiving and processing input from input device 520. A user interface may include, among other possibilities, a web browser and client application. Web browsers enable users, such as user 501, to display and interact with media and other information typically embedded on a web page or a website from server system 201. A client application allows user 501 to interact with a server application from server system 201. For example, the client application may allow user 501 to submit a payee file 120 to payee verification processor 130.

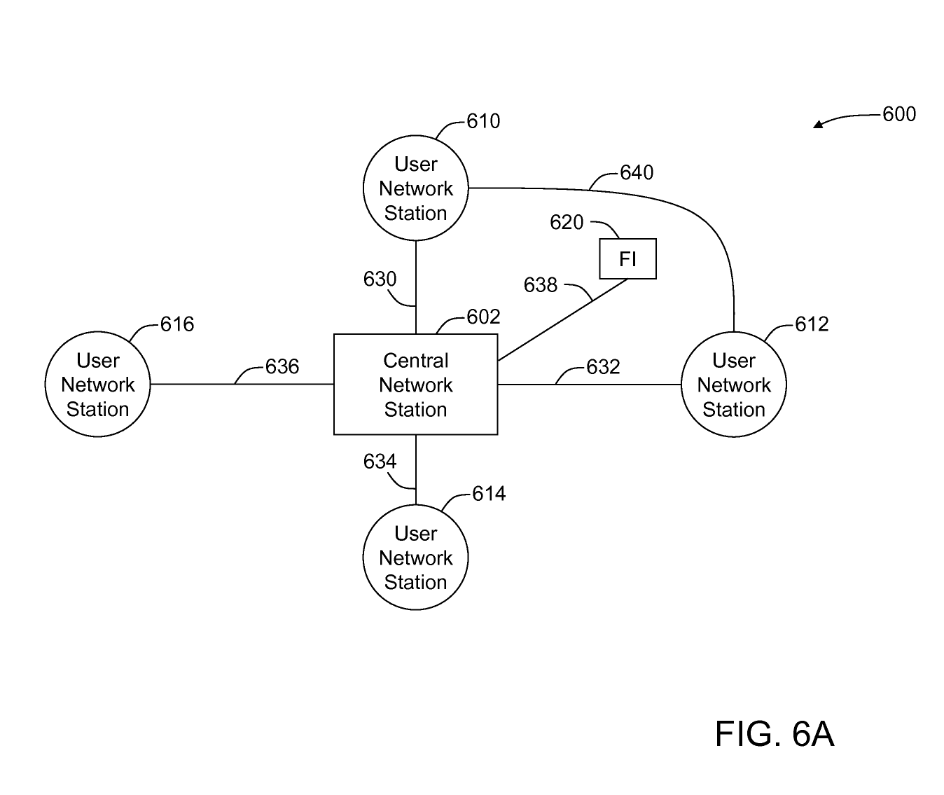

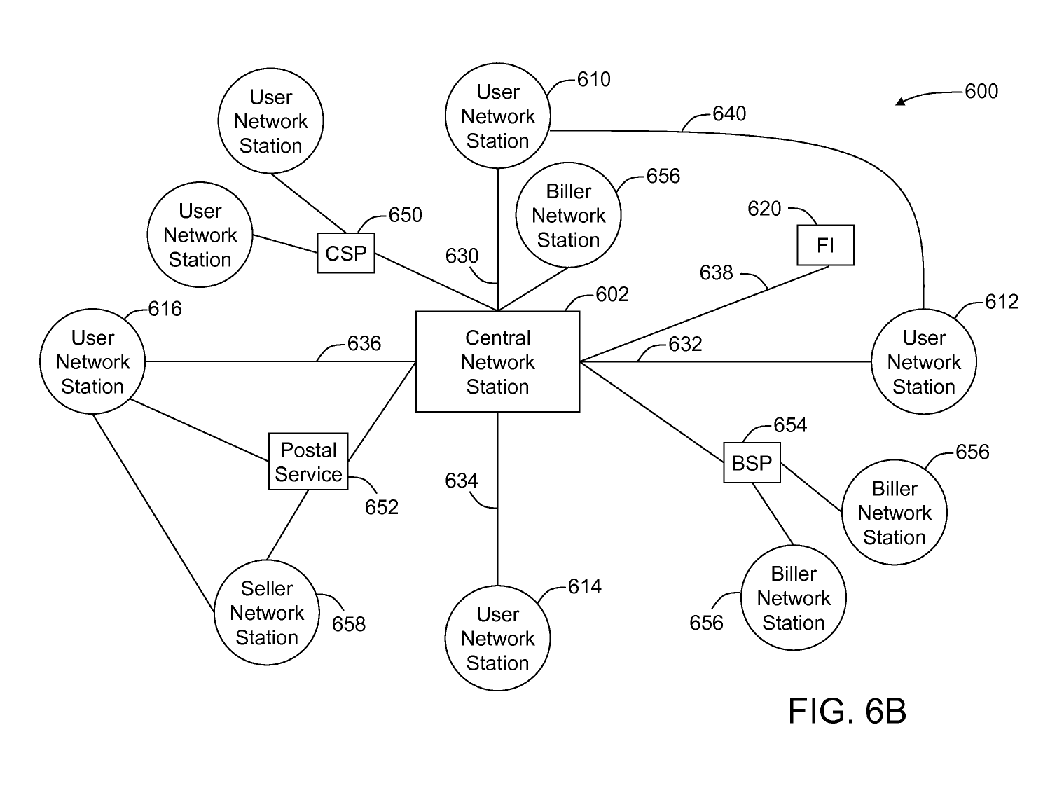

FIG. 6A is a generalized exemplary depiction of a conventional electronic financial service network 600. In a most basic form, such a network typically comprises a central network station 602 in communication with multiple user network stations 610, 612, 614, 616. Network users, who are customers of the financial service network 600, direct the central network station 602 to perform or facilitate financial transactions and/or services on their behalf. These directions are made via user network stations 610-616. A user network station is typically a personal computer, including client system 502, though it could be another type device. Another type device could be, but is not limited to, a telephone, a personal digital assistant, a set top box, or a computing device even more powerful than a personal computer. The financial transactions and services typically include, but are not limited to, bill and/or invoice presentment, bill and/or invoice payment, investment services, person-to-person payments, transmissions of financial information, home banking transactions, and purchase transactions. The central network station 602 conventionally maintains a central repository of information relating to services and transactions performed and/or facilitated and disseminates portions of this information to and between respective participants in the network 600, including those associated with user network stations 610-616 as well as other participants to be discussed below. Central network station 602 may include biller database 150, payee verification processor 130, originator database 140, and/or electronic payment system 170. In providing and/or facilitating some electronic financial services, the central network station 602 causes funds to move among and between deposit accounts associated with various ones of the network users and a deposit account associated with the central network station 602 maintained at a financial institution (FI) 620. Additionally, other types of accounts are often used to move funds, such as stored value accounts and credit accounts.

Each of the user network stations 610-616 communicates with the central network station 602 via a communication link 630, 632, 634, 636 and 638. A communication link can be established via, but is not limited to, conventional dial-up phone service, wireless phone service, including digital, analog and hybrid systems, an intranet, an extranet, a LAN, a WAN, and the Internet. Additionally, two or more of the user network stations 610-616 often communicate directly with one another via a communication link. For example, as shown in FIG. 6A, user network stations 610 and 612 communicate with one another via communication link 640. Communications between a user network station and the central network station, as well as between user network stations, can be made in several forms. They can be real-time communications, also known as in-session communications, they can be made by asynchronous messaging, or they can be made by asynchronous batch file transmission and processing.

Oftentimes two or more user network stations communicate with one another via the central network station. For example, user network stations 614 and 616 communicate with one another via communication links 634 and 636, with the communications traveling through the central network station 602. The communications between user network stations are often the basis of the financial transactions and/or services performed or facilitated by the central network station 602. These communications include purchase agreements, investment agreements, as well as other agreements relating to financial matters. It should also be noted that communications between network users not made via user network stations can also be the basis of the financial transactions and/or services performed or facilitated by the central network station 602. Network users include, but are not limited to, originator 110, individuals, businesses, educational institutions, and other organizations.

FIG. 6B is a further depiction of the conventional electronic financial service network 600 of FIG. 6A. FIG. 6B shows additional participants often found in conventional electronic financial service networks, as well as communication links between and among the additional and prior depicted network participants. It should be understood that not all conventional electronic financial service networks include each of the types of participants depicted in FIG. 6B. Furthermore, not all electronic financial service networks provide the same services. The exemplary electronic financial service network 600 includes a consumer service provider 650 (CSP), a postal service 652, a biller service provider 654 (BSP), additional user network stations, multiple biller network stations 656, and a seller network station 658. It will be appreciated that a biller and a seller are each network users. Furthermore, network stations associated with billers and sellers are, for clarity, labeled biller network stations and seller network stations to highlight their associated network user's roles in the electronic financial service network 600. It also will be appreciated that a given network user could have multiple roles. That is, a biller could also be a payor, and so on.

A consumer service provider 650 provides interface access to the central network station 602, and thus network 600, for some network users. A bank or other financial or investment institution is often a consumer service provider. A CSP is also known as a portal. Additionally, a CSP can also offer services to a network user beyond those offered by the central network station 602. Oftentimes the central network station 602 operates behind the scenes in relation to CSP 650. That is, the central network station 602 provides the functionality to provide and/or facilitate financial transactions and/or services, while CSP 650 controls the presentation of such functionality to a network user.

Billers, who access network 600 through biller network stations 656, often electronically present their customer's bills or invoices for services rendered and/or products sold. The central network station 602 typically receives billing information from billers and then presents either summary or complete billing information to payers. Billers also often receive remittance advice via network 600 for payment of bills, both those presented via network 600, and those only paid via network 600. A biller's access to the central network station 602 is sometimes through a BSP 654 which processes bills for several billers.

The FI 620, introduced above, provides access to at least one financial institution network, including the Automated Clearing House (ACH) network or FEDWIRE network, for financial transactions performed or facilitated by the central network station 602. FI 620 also hosts at least one deposit account associated with network 600. The financial institution also provides other services for the network 600, including settlement and treasury functions. As shown in FIG. 6B, central network station 602 also directly accesses other type financial networks. These networks include credit card networks and ATM/POS networks.

A postal service 652 performs delivery of goods purchased by network users and tracks the movement of these goods. This service could be provided in concert with central network station 602. A postal service is a participant in payment-on-delivery transactions.

Introduced above, the central network station 602 causes movement of funds between and among deposit accounts. These movements of funds are either by paper movement or electronic movement. Paper movement of funds includes checks and drafts prepared under the direction of the central station 602. These checks or drafts may be drawn on an account associated with the central network station 602 and payable to a payee designated by a network user. Or, these checks or drafts may be drawn on an account maintained at a financial institution associated with a network user and payable to a payee designated by a network user or deposited into an account associated with the central network station 602.

Electronic movement of funds is also by direction of the central network station 602. As introduced above, the central network station 602 is associated with a financial institution 620 that performs electronic movement of funds on behalf of the central network station 602. Like paper movement of funds, electronic movement of funds may originate from an account associated with the central network station 602, or may originate from an account associated with a network user. A network user must provide account information to the central network station 602 so that the central network station 602 can access that network user's account, whether the access is electronic or paper.

Some electronic financial service networks are closed systems. In a closed system, funds only move among and between individuals or entities that have a pre-established relationship with the central network station of the respective network. Additionally, information typically flows exclusively electronically in closed systems. Individuals and entities with pre-established relationships with a central network station are known as registered users. In these closed systems, funds can move either electronically or by paper, though preferably electronically. Other electronic financial service networks are open systems. In an open system, funds can move not only among and between registered users, but also to unregistered recipients. For movement to an unregistered recipient, funds must move by paper methods, as a central network station directing the transaction does not have access to the recipient's account.

It will be recognized by one skilled in the art that electronic movement of funds is more efficient than paper movement of funds. This efficiency arises because of at least two reasons. First, the cost per transaction is less for electronic movement than paper movement. Second, electronic movements require less time to complete than paper movements. Likewise, it will be recognized that electronic movement of information is also more efficient than paper movement of information.

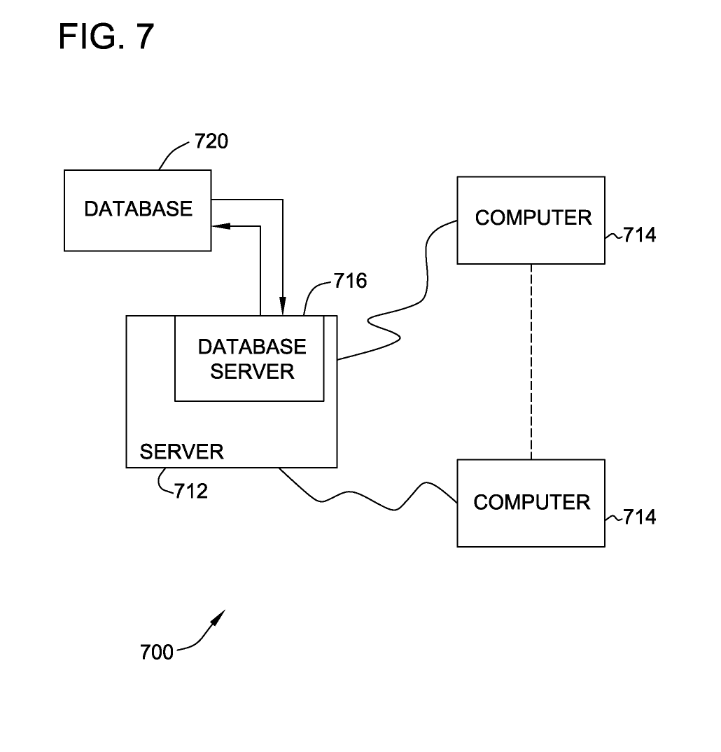

FIG. 7 is a simplified block diagram of an exemplary system 700 for use with system 100 shown in FIG. 1. In one embodiment, system 700 is similar to electronic payment system 170 shown in FIG. 1. More specifically, in the example embodiment, system 700 includes a server system 712, and a plurality of client sub-systems, also referred to as client systems 714, connected to server system 712. Client systems 714 may be the same as user network stations 610, 612, 614, and 616. System 700 is sometimes referred to as the RPPS® (Remote Payment and Presentment Service) system or the payment system. (RPPS is a registered trademark of MasterCard International Incorporated.) In one embodiment, client systems 714 are computers including a web browser, such that server system 712 is accessible to client systems 714 using the Internet. Client systems 714 are interconnected to the Internet through many interfaces including a network, such as a local area network (LAN) or a wide area network (WAN), dial-in-connections, cable modems and special high-speed ISDN lines. Client systems 714 could be any device capable of interconnecting to the Internet including a web-based phone, personal digital assistant (PDA), or other web-based connectable equipment. A database server 716 is connected to a database 720 containing information on a variety of matters, as described below in greater detail. In one embodiment, centralized database 720 is stored on server system 712 and can be accessed by potential users at one of client systems 714 by logging onto server system 712 through one of client systems 714. In an alternative embodiment, database 720 is stored remotely from server system 712 and may be non-centralized.

As discussed below, a biller directory, e.g., biller database 150, and/or other consumer related data including data utilized and processed by the billers can be stored within database 720. For example, the biller directory may include a list of billers registered to receive payments electronically, a format or structure of consumer account related information that is acceptable for each biller (also referred to herein as an account mask or billing account structure) for processing payments electronically, exception masks associated with the registered billers if required by the particular biller, a list of consumer accounts that are registered for electronic processing of payments, and other consumer related information such as names of the consumers, addresses and telephone numbers, other consumer identifiers, account numbers and payment histories. Other data may also be stored within database 720 including originator database 140 and/or exception payment batch files. In addition, similar data or other billing and consumer related data may also be stored within other databases such as a database associated with billers and/or a database associated with originators.

The embodiments illustrated and described herein as well as embodiments not specifically described herein but within the scope of aspects of the invention constitute exemplary means for the electronic processing of financial transactions, and more particularly, constitute exemplary means for the electronic processing of financial transactions having a payment included therewith in order to affect payment of a bill. For example, the server system 712 or the client system 714, or any other similar computer device, programmed with computer-executable instructions illustrated in FIG. 7 constitutes exemplary means for the electronic processing of financial transactions having an exception payment included therewith in order to affect payment of a bill.

As used herein, an originator includes any entity providing a consumer with a service to facilitate on-line bill payment. For example, an originator may include a financial institution such as a bank or a third-party entity used by a bank for processing on-line payments for consumers. An originator may also include or be referred to as a consumer service provider (CSP). A biller is typically a merchant or an entity that provides a good or service to a consumer. A biller service provider is an entity that provides a biller with a service to allow the biller to receive bill payments. In some cases, a biller can also serve as a biller service provider for themselves or other billers. Accordingly, as used herein, in at least some cases the biller and the biller service provider can be the same entity.

In an alternative embodiment, some or all of the tasks described above as being performed by the originator, the biller service provider and/or the biller are performed by payment system 700. For example, in an alternative embodiment, the originators and billers opting to use the payment system (i.e., sending and receiving exception payments electronically) are stored within the payment system.

In at least some known electronic bill payment systems, payments are originated by a bill payment service provider, which is also known as an originator. These payments may be fulfilled either via an electronic transaction or via a paper check. The determination of whether a bill payment is fulfilled electronically or via check is based on the data the consumer enters for the payment. If the data entered matches billing data (account masks, remittance address, check digit routine, etc.) provided by a biller or payor, and are reflected on a biller directory provided to the bill payment service provider, then the payment can be fulfilled electronically by the bill payment service provider (originator). If the data entered by the consumer does not match the billing data provided by the biller and stored on the biller directory, an originator will have to create a paper check containing the consumer entered data for the payment method. The paper check is then provided to the biller or the biller's service provider.

It should be noted that originators prefer to fulfill transactions electronically for several reasons. First, it is a lower cost fulfillment method. Typically, an electronic fulfillment method costs the originator $0.10 or less, while a paper check will cost them $0.40-$0.50 per item. Secondly, the payment is posted more quickly if it is fulfilled electronically, which leads to greater customer satisfaction. The originator is typically any entity that provides a consumer with a service to facilitate on-line bill payment. For example, an originator may include a financial institution such as a bank or a third-party entity used by a bank for processing on-line payments for consumers.

As more and more consumers pay their bills on-line using bill payment services, billers are receiving more and more paper check items. The systems and processes described herein enable billers to electronically receive payment, even if the consumer entered data is not an exact match to the criteria the biller provides for valid electronic payments. In other words, the systems and process described herein enable billers to electronically receive payment in those cases where the consumer entered payment data does not match the account mask or other information required by the biller for accepting such a payment.

In the example embodiment, a RPPS biller directory, e.g., biller database 150, contains a list of electronic billers and their accompanying payment data. If the payment data provided by the originator meets the data requirements outlined in the biller directory, RPPS system 700 will process, route and settle the payment electronically. The biller directory may be stored on payment system 700. For example, the biller directory may be stored on database 720. In one embodiment, the biller directory is downloaded from payment system 700 to a computer system associated with the originator. In another embodiment, the biller directory is stored at payment system 700 and the originator system retrieves information from the biller directory as needed.

As used herein, an exception mask is a minimum criterion or criteria that a biller requires in order to agree to accept an exception payment electronically from a consumer. For example, an account number for a biller may include ten (10) digits with the first two digits being alpha and the last eight digits being numeric, and therefore, the biller may require the exception mask to be that the first two alpha digits are correctly entered and at least four of the last eight numeric digits are correctly entered before the biller will accept payment electronically as an exception payment. In the example embodiment, a biller is not required to establish exception masks. In other words, a biller is not required to have a minimum criterion or criteria (i.e., a minimum amount of correctly inputted consumer information) before accepting an exception payment electronically, but rather a biller not requiring an exception mask will accept an exception payment electronically without conditions or requirements on the amount or type of information correctly inputted by the consumer.

In contrast, an account mask is a format or structure of consumer account related information that is acceptable for a biller for processing payments electronically. For example, an account mask or structure for a biller may include ten (10) digits with the first two digits being alpha and the last eight digits being numeric. In this case, when a consumer enters information to make an electronic payment and enters their consumer account number, the system compares the consumer entered account number to the account mask for the biller to determine whether the structure of the entered account number matches the account mask. If so, the payment is processed electronically. If there is not a match, then the payment may be designated as an exception payment for further processing including determining whether an exception mask, if applicable, is satisfied.

In one embodiment, a computer program is provided, and the program is embodied on a computer readable medium and utilizes a Structured Query Language (SQL) with a client user interface front-end for administration and a web interface for standard user input and reports. In an exemplary embodiment, the system is web enabled and is run on a business-entity intranet. In yet another embodiment, the system is fully accessed by individuals having an authorized access outside the firewall of the business-entity through the Internet. In a further exemplary embodiment, the system is being run in a Windows® environment (Windows is a registered trademark of Microsoft Corporation, Redmond, Wash.). The application is flexible and designed to run in various different environments without compromising any major functionality.

The systems and processes are not limited to the specific embodiments described herein. In addition, components of each system and each process can be practiced independent and separate from other components and processes described herein. Each component and process also can be used in combination with other assembly packages and processes.

The term processor, as used herein, may refer to central processing units, microprocessors, microcontrollers, reduced instruction set circuits (RISC), application specific integrated circuits (ASIC), logic circuits, and any other circuit or processor capable of executing the functions described herein.

As used herein, the terms “software” and “firmware” are interchangeable, and include any computer program stored in memory for execution by a processor, including RAM memory, ROM memory, EPROM memory, EEPROM memory, and non-volatile RAM (NVRAM) memory. The above memory types are exemplary only, and are thus not limiting as to the types of memory usable for storage of a computer program.

As will be appreciated based on the foregoing specification, the above-described embodiments of the disclosure may be implemented using computer programming or engineering techniques including computer software, firmware, hardware or any combination or subset thereof, wherein the technical effect is receiving a payee input file, determining whether each payee in the payee input file matches a biller in a biller database, and outputting an output file that indicates whether each payee was matched to a biller. Any such resulting program, having computer-readable code means, may be embodied or provided within one or more computer-readable media, thereby making a computer program product, i.e., an article of manufacture, according to the discussed embodiments of the disclosure. The computer-readable media may be, for example, but is not limited to, a fixed (hard) drive, diskette, optical disk, magnetic tape, semiconductor memory such as read-only memory (ROM), and/or any transmitting/receiving medium such as the Internet or other communication network or link. The article of manufacture containing the computer code may be made and/or used by executing the code directly from one medium, by copying the code from one medium to another medium, or by transmitting the code over a network.

The above-described embodiments of methods and systems of maximizing electronic payments provide a cost-effective and reliable means for determining whether a payee is capable of receiving electronic payments. As a result, the methods and systems described herein facilitate maximizing electronic payments by identifying payees capable of receiving electronic payments.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

1. A computer system for verifying payee information in an electronic payment, said computer system comprising a memory device and a processor, said computer system programmed to:
receive a payee file that includes payee information identifying a payee, wherein the payee issues a bill for payment to a payor;
determine a match score by comparing the payee information with biller information stored within a directory of electronic billers;
verify that the payee matches at least one electronic biller stored within the directory of electronic billers based on the match score; and
generate an output file including at least one of an electronic biller identifier corresponding to the payee in the payee file if verification is confirmed and a no match indicator if no match was verified.

2. A system in accordance with claim 1, wherein the payee file includes payee information about a plurality of payees, and the payee information includes at least one of a name, an address, a state, a zip code, and an account number.

3. A system in accordance with claim 2, wherein the computer system is further programmed to determine a match score for each payee in the plurality of payees.

4. A system in accordance with claim 1, wherein the payee information includes a first account number, and wherein said computer system is further programmed to determine a second account number based on the first account number.

5. A system in accordance with claim 1, further comprising an electronic payment system configured to receive payment information and to transmit a payment to a biller.

6. A system in accordance with claim 1, wherein the directory of electronic payees includes an account mask that represents a pre-determined account number format.

7. A system in accordance with claim 6, wherein the system is further programmed to alter, using the account mask, a consumer account number and process a payment using the altered consumer account number.

8. A system in accordance with claim 1, wherein payee information includes at least one of a name, an address, a state, a zip code, and an account number, wherein the system is further programmed to:
determine the match score based on the name, the address, the state, the zip code, and the account number; and
determine a confidence score based on the name, the address, the state, and the zip code, wherein the match score is used to rank two or more matches and the confidence score is used to determine whether to output a match.

9. A computer-based method for verifying payee information in an electronic payment using a computer device in communication with a database that includes a directory of electronic billers, said method comprising:
receiving a payee file that includes payee information identifying a payee, wherein the payee issues a bill for payment to a payor;
determining a match score by comparing the payee information with biller information stored within a directory of electronic billers;
verifying that the payee matches at least one electronic biller stored within the directory of electronic billers based on the match score; and
generating an output file including at least one of an electronic biller identifier corresponding to the payee in the payee file if verification is confirmed and a no match indicator if no match was verified.

10. A method in accordance with claim 9, wherein receiving a payee file comprising receiving a payee file that includes payee information about a plurality of payees, and the payee information includes at least one of a name, an address, a state, a zip code, and an account number.

11. A method in accordance with claim 10, wherein determining whether the payee is included in the directory of electronic payees comprises determining whether each payee in the plurality of payees is included in the directory of electronic payees based on the payee information about each payee.

12. A method in accordance with claim 9, wherein receiving a payee file that includes payee information comprises receiving a first account number, said method further comprising determining a second account number based on the first account number.

13. A method in accordance with claim 9, further comprising providing at least one account mask in the directory of electronic payees, wherein the at least one account mask represents a pre-determined account number format.

14. A method in accordance with claim 13, further comprising altering, using the at least one account mask, a consumer account number, and processing a payment using the altered consumer account number.

15. A method in accordance with claim 9, wherein receiving a payee file that includes payee information comprises receiving at least one of a name, an address, a state, a zip code, and an account number, wherein determining a match score comprises determining a match score based on the name, the address, the state, the zip code, and the account number, said method further comprising determining a confidence score based on the name, the address, the state, and the zip code, wherein the match score is used to rank two or more matches and the confidence score is used to determine whether to output a match.

16. At least one non-transitory computer-readable storage media having computer-executable instructions embodied thereon, wherein when executed by at least one processor, the computer-executable instructions cause the processor to:
receive a payee file that includes payee information identifying a payee, wherein the payee issues a bill for payment to a payor;
determine a match score by comparing the payee information with biller information stored within a directory of electronic billers;
verify that the payee matches at least one electronic biller stored within the directory of electronic billers based on the match score; and
generate an output file including at least one of an electronic biller identifier that corresponds to the payee in the payee file if verification is confirmed and a no match indicator if no match was verified.

17. The computer-readable storage media of claim 16, wherein the payee file includes payee information about a plurality of payees, and the payee information includes at least one of a name, an address, a state, a zip code, and an account number.

18. The computer-readable storage media of claim 16, wherein the directory of electronic payees comprises at least one account mask representing a pre-determined account number format.

19. The computer-readable storage media of claim 18, wherein the computer-executable instructions further cause the processor to alter, using the account mask, a consumer account number and process a payment using the altered consumer account number.

20. The computer-readable storage media of claim 19, wherein payee information includes at least one of a name, an address, a state, a zip code, and an account number, wherein the computer-executable instructions further cause the processor to:
determine the match score based on the name, the address, the state, the zip code, and the account number; and
determine a confidence score based on the name, the address, the state, and the zip code, wherein the match score is used to rank two or more matches and the confidence score is used to determine whether to output a match.
